(19) United States
(12) Patent Application Publication
(10) Pub. No.: US 2006/0176423 A1
(43) Pub. Date: Aug. 10, 2006

(54) Polarizer and liquid crystal display using such a polarizer

(76) Inventor: Jae-Ho Lee, Seoul (KR)

Correspondence Address: CANTOR COLBURN, LLP, 55 GRIFFIN ROAD SOUTH, BLOOMFIELD, CT, 06002, US

(21) Appl. No.: 11/346,458

(22) Filed: Feb. 2, 2006

(30) Foreign Application Priority Data
Feb. 4, 2005 (KR) 10-2005-0010608

(51) Int. Cl. G02F 1/1335

(52) U.S. Cl. 349/96

(57) ABSTRACT

An LCD includes a first insulating substrate, a gate line formed on the first insulating substrate, a data line formed on the first insulating substrate and crossed with the gate line at a right angle, a thin film transistor (“TFT”) connected to the gate line and the date line, a pixel electrode connected to the TFT, a second insulating substrate placed opposite to the first insulating substrate, a common electrode formed on the second insulating substrate, an LC layer interposed between the first insulating substrate and the second insulating substrate, and a polarizer attached to either of outer surfaces of the first and second insulating substrates. The polarizer includes a polarizing medium layer and a passivation layer, formed on or under the polarizing medium layer and containing at least one conductive polymer selected from a group consisting of polyaniline, polythiophene, and polypyrrole.

This application claims priority to Korean Patent Application No. 10-2005-0010608, file on Feb. 4, 2005 and all the benefits accruing therefrom under 35 U.S.C. §119, and the contents of which in its entirety are herein incorporated by reference.

### BACKGROUND OF THE INVENTION

1. (a) Field of the Invention

The present invention relates generally to a liquid crystal display (“LCD”), and more particularly to a polarizer that is capable of efficiently eliminating a static charge that is introduced from an exterior and an LCD employing the polarizer.

2. (b) Description of the Related Art

Liquid crystal displays (“LCDs”) have been widely used devices among flat panel display devices. Generally, an LCD includes a pair of opposed panels, such as a TFT array panel and a common electrode panel, with field-generating electrodes on their inner surfaces, and a liquid crystal (LC) layer interposed between the panels. In an LCD, a variation of a voltage difference between the field generating electrodes, i.e., a variation in strength of an electric field generated by the electrodes such as pixel electrodes on the TFT array panel and a common electrode on the common electrode panel, changes the transmittance of light passing through the LCD by varying an arrangement of the LC molecules within the LC layer, and thus desired images are obtained by controlling the voltage difference between the electrodes.

Depending on the kinds of techniques used to align LC molecules in the LC layer, LCDs are categorized into three types including twisted nematic (“TN”) mode, in-plane switching (“IPS”) mode, and vertical alignment (“VA”) mode LCDs. Of the three, a VA mode LCD, in which lone axes of the LC molecules are aligned perpendicular to the surfaces of the panels in the absence of an electric field, has been spotlighted the most because of its larger contrast ratio and wider viewing angle.

In the field of VA mode LCDs, various methods have been proposed to enlarge the viewing angle. A widely used method is to form apertures (or cutting portions) in the field-generating electrodes. Another method is to form protrusions on the field-generating electrodes. In both cases, the apertures and the protrusions determine tilt directions of the LC molecules. Accordingly, when the apertures or the protrusions are formed in a desirable manner, the viewing angle of the LCD becomes wider.

However, the VA mode LCD is very delicate with respect to a static charge. Particularly, when organic layers are incorporated in such an LCD to achieve a high aperture rate and/or the size of the LCD is relatively large, the static charge may cause serious problems.

### BRIEF SUMMARY OF THE INVENTION

The present invention provides a polarizer that is capable of efficiently eliminating a static charge that is introduced from the outside of an LCD, and an LCD employing the same polarizer.

According to exemplary embodiments of the present invention, a polarizer is provided that includes a polarizing medium layer, and a passivation layer that is formed on or under the polarizing medium layer.

In these embodiments, the passivation layer includes at least one conductive polymer selected from a group consisting of polyaniline, polythiophene, and polypyrrole.

According to other exemplary embodiments of the present invention, an LCD is provided that includes a first insulating substrate, a gate line formed on the first insulating substrate, a data line formed on the first insulating substrate and crossed with the gate line at a right angle, a thin film transistor (“TFT”) connected to the gate line and the date line, a pixel electrode connected to the TFT, a second insulating substrate placed opposite to the first insulating substrate, a common electrode formed on the second substrate, an LC layer interposed between the first insulating substrate and the second insulating substrate, and a polarizer attached to either outer surfaces of the first and second insulating substrates.

In these embodiments, the polarizer includes a polarizing medium layer and a passivation layer, which is formed on or under the polarizing medium layer and contains at least one conductive polymer selected from a group consisting of polyaniline, polythiophene, and polypyrrole.

### BRIEF DESCRIPTION OF THE DRAWINGS

The above features and advantages of the present invention will become more apparent by describing the preferred embodiments thereof in more detail with reference to the accompanying drawings, wherein:

FIG. 1 is a schematic cross-sectional view showing an exemplary embodiment of a polarizer according to the present invention;

FIG. 2 is a schematic cross-sectional view of another exemplary embodiment of a polarizer according to the present invention;

FIG. 3 is a layout view of an exemplary embodiment of a TFT array panel of an LCD according to the present invention;

FIG. 4 is a layout view of an exemplary embodiment of a common electrode panel of an LCD according to the present invention;

FIG. 5 is a layout view of an LCD incorporating the exemplary TFT array panel of FIG. 3 and the exemplary common electrode panel of FIG. 4; and, FIG. 6 is a cross-sectional view cut along line VI-VI′ of FIG. 5.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless 10 the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

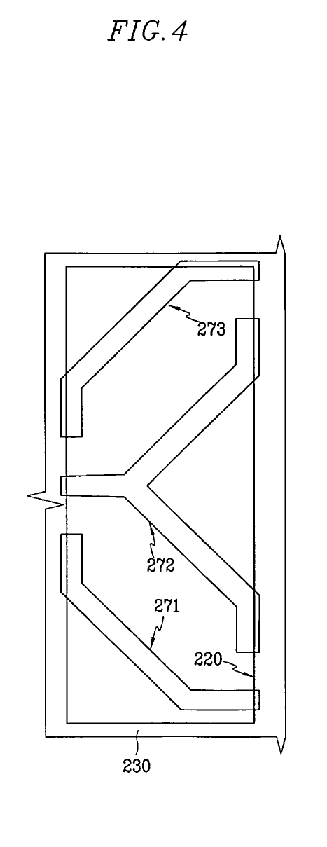

In the drawings, the thickness of the layers, films, and regions are exaggerated for clarity. Hereinafter, an exemplary embodiment of an LCD according to the present invention will be described in detail with reference to FIG. 3 through FIG. 6.

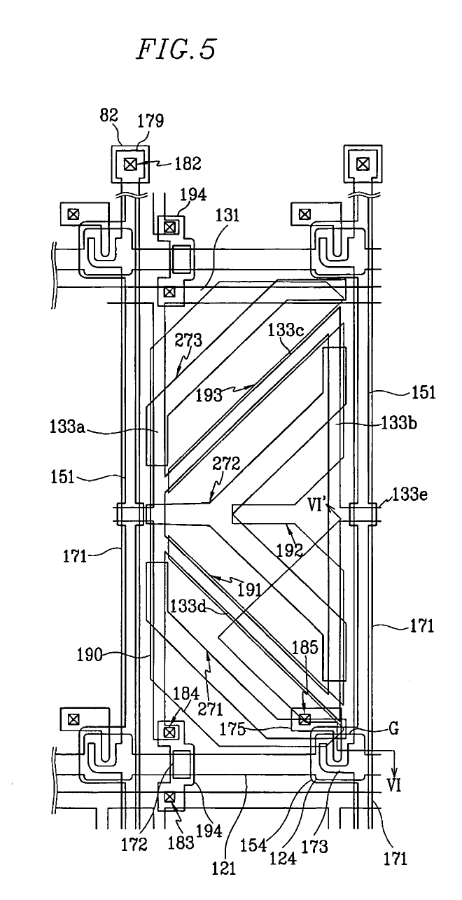

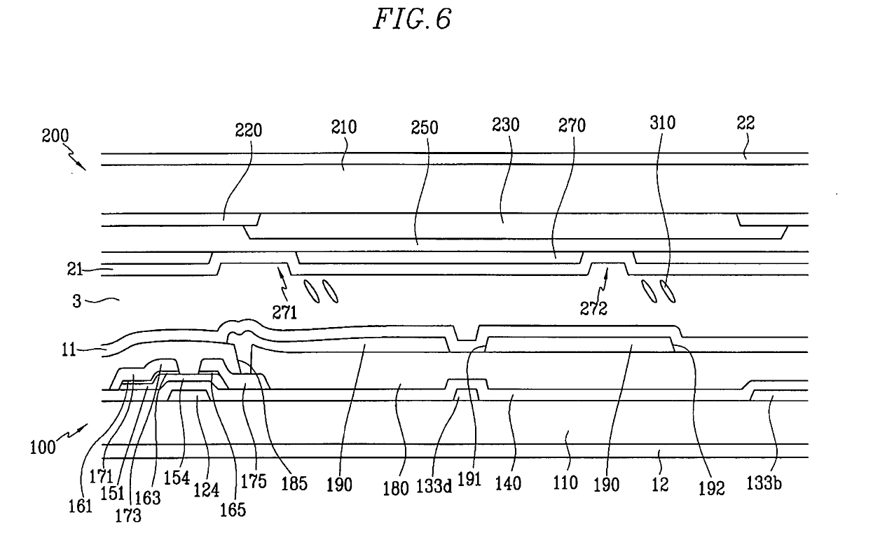

FIG. 3 is a layout view of an exemplary embodiment of a TFT array panel of an LCD according to the present invention, FIG. 4 is a layout view of an exemplary embodiment of a common electrode panel of an LCD according to the present invention, FIG. 5 is a layout view of an LCD incorporating the exemplary TFT array panel of FIG. 3 and the exemplary common electrode panel of FIG. 4, and FIG. 6 is a cross-sectional view cut along line VI-VI′ of FIG. 5.

Referring to FIG. 3 through FIG. 6, the LCD includes a TFT array panel 100 and a common electrode panel 200 facing each other, and an LC layer 3 that is interposed therebetween with a plurality of LC molecules 310.

The TFT array panel 100 is configured as follows.

A plurality of gate lines 121 and a plurality of storage electrode lines 131 are formed on an insulating substrate 110 made of transparent glass or the like.

The gate lines 121 for transmitting gate signals extend in a first direction substantially in a horizontal direction and are separated from each other. Each gate line 121 includes a plurality of gate electrodes 124, where each gate electrode 124 is positioned within a pixel area of the TFT array panel. An end portion of each gate line includes a relatively large dimension so as to connect each gate line to a different layer or an external device.

The storage electrode lines 131 receive a predetermined voltage. Each storage electrode line 131 includes a stem line extending in the first direction that is substantially parallel to the gate lines 121, a plurality of groups of storage electrodes 133a, 133b, 133c, and 133d, and a plurality of connecting parts 133e. Each storage electrode line 131 is placed between two adjacent gate lines 121, and the stem line of the storage electrode line 131 is closer to one of the two adjacent gate lines 121. As illustrated in FIG. 3, the stem line of the storage electrode line 131 is placed closer to the upper positioned gate line 121 adjacent a pixel area of the two adjacent gate lines 121 flanking a pixel area. In a group of the storage electrodes, a first storage electrode 133a and a second storage electrode 133b extend in a vertical direction, such as a second direction substantially perpendicular to the first direction, and are parallel to each other. A third storage electrode 133c extends in the form of a slanted line that starts from a point close to the middle of the first storage electrode 133a and meets an upper end of the second storage electrode 133b. A fourth storage electrode 133c extends in the form of a slanted line that starts from another point close to the middle of the first storage electrode 133a and meets a lower end of the second storage electrode 133b. More specifically, the first storage electrode 133a has a fixed end that is connected to one of the stem lines of the storage electrode line 131 and a free end having a projection. Each connecting part 133e connects the first storage electrode 133a of a group and the second storage electrode 133b of an adjacent group. In the illustrated embodiment, the connecting part 133e extends substantially in the first direction perpendicular to the first and second storage electrodes 133a and 133b, such that the first storage electrode 133a of one pixel area is connected to the second storage electrode 133b of an adjacent pixel area.

The storage electrode lines 131 receive the predetermined voltage, as mentioned above, such as a common voltage Vcom that will be applied to a common electrode 270 of the common electrode panel 200, as will be further described below. While only one stem line is shown in. FIG. 3, in an alternative embodiment each storage electrode line 131 may include a pair of stem lines that extend in a horizontal direction.

The gate lines 121 and the storage electrode lines 131 are preferably made of an aluminum-(Al) containing metal such as Al or an Al alloy, a silver-(Ag) containing metal such as Ag or a Ag alloy, a copper-(Cu) containing metal such as Cu or a Cu alloy, a molybdenum-(Mo) containing metal such as Mo or a Mo alloy, chromium (Cr), titanium (Ti), or tantalum (Ta). The gate lines 121 and the storage electrode lines 131 may be configured as a multi-layered structure, in which at least two conductive layers (not shown) having different physical properties may be included. In such a structure, one of the two conductive layers is made of a low resistivity metal, such as an Al-containing metal, an Ag-containing metal, or a Cu-containing metal, in order to reduce delay of the signals or voltage drop in the gate lines 121 and the storage electrode lines 131. The other conductive layer is made of a material having good physical, chemical, and electrical contact properties with other materials such as indium tin oxide (“ITO”) and indium zinc oxide (“IZO”). For example, a Mo-containing metal, Cr, Ta, and Ti may be used to form the same layer. Desirable examples of the combination of the two layers are a lower Cr layer and an upper Al layer, and a lower Al layer and an upper Mo layer. In any combination of the above, the gate lines 121 and the storage electrode lines 131 may be formed on the insulating substrate 110 within a same process during the manufacture of the TFT array panel 100.

All lateral sides of the gate lines 121 and the storage electrode lines 131 preferably slope between about 20° and about 80° relative to the surface of the insulating substrate 110.

A gate insulating layer 140 made of silicon nitride (SiNx) is formed on the gate lines 121 and the storage electrode lines 131, and may be further formed on any exposed portions of the insulating substrate 110 not covered by the gate lines 121 or storage electrode lines 131.

A plurality of linear semiconductors 151 made of hydrogenated amorphous silicon ( “a-Si”) or polysilicon, are formed on the gate insulating layer 140. Each linear semiconductor 151 extends substantially in a vertical direction, such as the second direction parallel to the first and second storage electrodes 133a and 133a, and includes a plurality of projections 154 that extend along the respective gate electrodes 124.

A plurality of linear ohmic contacts 161 and island-shaped ohmic contacts 165 are formed on the linear semiconductors 151. The ohmic contacts 161 and 165 may be made of silicide or N+ hydrogenated a-Si that is highly doped with N-type impurities. The linear ohmic contacts 161 include a plurality of projections 163. A set of a projection 163 and an island-shaped ohmic contact 165 are placed on the projection 154 of the semiconductor 151.

All lateral sides of the linear semiconductors 151 and the ohmic contacts 161 and 165 preferably slope between about 30° and about 80° relative to the surface of the insulating substrate 110.

A plurality of data lines 171, a plurality of drain electrodes 175 separated from the data lines 171, and a plurality of metal pieces 172 are formed on the ohmic contacts 161 and 165 and the gate insulating layer 140.

The data lines 171 for transmitting data signals extend substantially in a vertical direction, that is the second direction perpendicular to the first direction in which the gate lines 121 extend, and cross the gate lines 121, the stem lines of the storage electrode lines 131, and the connecting parts 133e. The data lines 171 are insulated from the gate lines 121 by the gate insulating layer 140. Each group of the storage electrodes 133a, 133b, 133c, and 133d is placed between two adjacent data lines 171. Each data line 171 includes a plurality of source electrodes 173 extending toward the respective gate electrodes 124, and an end portion 179 having a relatively large dimension to be connected to a different layer or an external device.

A gate electrode 124, a source electrode 173, a drain electrode 175, and a projection 154 of the semiconductor 151 form a thin film transistor (“TFT”) which serves as a switching element for each pixel of the TFT array panel 100. A TFT channel is formed in the projection 154 provided between the source electrode 173 and the drain electrode 175.

Each metal piece 172 is disposed on a partial portion of the gate line 121, which is positioned closer to the projection of the free end of the first storage electrode 133a than to the second storage electrode 133b. In other words, the metal piece 172 as is located within a lower left comer of a pixel area as defined by a pair of adjacent data lines 171 and a pair of gate lines 121.

The data lines 171, the drain electrodes 175, and the metal pieces 172 are preferably made of a refractory metal such as Mo, Cr, Ta, or Ti, or any of their alloys, and may be configured as multi-layered structures including a refractory metal layer (not shown) and a low resistivity conductive layer (not shown). Desirable examples of the multi-layered structure include, but are not limited to, a lower Cr layer and an upper Al layer, and a lower Al layer and an upper Mo layer. Another example is a lower Mo layer, an intermediate Al layer, and an upper Mo layer.

All lateral sides of the data lines 171, the drain electrodes 175, and the metal pieces 172 preferably slope between about 30° and about 80° relative to the surface of the insulating substrate 110.

The ohmic contacts 161 and 165 exist only between the underlying semiconductors 151 and the overlying data lines 171 and between the overlying drain electrodes 175 and the underlying semiconductors 151, in order to reduce contact resistance. The linear semiconductors 151 are partially exposed at places where the data lines 171 and the drain electrodes 175 do not cover them, as well as between the source electrodes 173 and the drain electrodes 175.

A passivation layer 180 is formed on the data lines 171, the drain electrodes 175, the metal pieces 172, and the exposed portions of the semiconductors 151, as well as over exposed portions of the gate insulating layer 140. The passivation layer 180 may be configured as a single layer made of an inorganic material such as SiNₓ or SiO₂, a photosensitive organic material having a good planarization property, or a low dielectric insulator having a dielectric constant of below 4.0. Desirable examples of the low dielectric insulator include, but are not limited to, a-Si:C:O, a-Si:O:F, etc., which are produced by plasma enhanced chemical vapor deposition (“PECVD”). However, in alternative embodiments, the passivation layer 180 may be configured as a double-layered structure including a lower inorganic insulator layer and an upper organic insulator layer. Such a structure improves a contact property with the semiconductors 151.

The passivation layer 180 is provided with a plurality of contact holes 182 and 185, through which the end portions 179 of the data lines 171 and the expansions of the drain electrodes 175 are exposed, respectively. A plurality of contact holes 183 and 184 are formed in the passivation layer 180 and the gate insulating layer 140 to exposed the partial stem lines of the storage electrode lines 131, which are connected to the fixed ends of the first storage electrodes 133a and the projections of the free ends of the first storage electrodes 133a, respectively. In other words, in the illustrated embodiment, the contact hole 183 is positioned adjacent an upper left comer of a pixel area, and the contact hole 184 is positioned in a lower left corner of a pixel area. Thus, the contact hole 183 of one pixel area is positioned adjacent the contact hole 184 of an adjacent pixel area.

A plurality of pixel electrodes 190, a plurality of contact assistants 82, and a plurality of overpasses 194 are formed on the passivation layer 180. They may be made of a transparent conductor, such as, but not limited to, ITO or IZO. The pixel electrodes 190, contact assistants 82, and overpasses 194 may be formed during a same process of a manufacturing method of the TFT array panel 100.

The pixel electrodes 190 are physically and electrically connected to the drain electrodes 175 through the contact holes 185 in order to receive data voltages from the drain electrodes 175.

The pixel electrodes 190 supplied with the data voltages generate electric fields in cooperation with the common electrode 270 of the common electrode panel 200, as will be further described below, thus determining the orientations of the LC molecules 310 in the LC layer 3 that is interposed between the two electrodes 190 and 270.

Each set of the pixel electrode 190 and the common electrode 270 forms an LC capacitor C_{LC} that is capable of storing a charge to maintain the applied voltage after the TFT of the TFT array panel 100 is turned off. Storage capacitors C_{ST}, which are connected to the LC capacitors C_{LC} in parallel, enhance the charge storage ability of the LC capacitors C_{LC}. Overlapping of the pixel electrodes 190 with the stem lines of the storage electrode lines 131 and the storage electrodes 133a, 133b, 133c, and 133d implements the storage capacitors C_{ST.}

Each pixel electrode 190 is shaped as a rectangle whose four corners are chamfered. Two vertical sides of the pixel electrode 190 are substantially parallel to the data lines 171, and two horizontal sides are substantially parallel to the gate lines 121. The chamfered corners are formed at about 45° relative to the gate lines 121 and the data lines 171.

Each pixel electrode 190 is provided with three cutting portions: a lower cutting portion 191, a central cutting portion 192, and an upper cutting portion 193. The three cutting portions 191, 192, and 193 partition each pixel electrode 190 into a plurality of sub-areas. The cutting portions 191, 192, and 193 are inversely symmetrical to a hypothetical horizontal central line bisecting the pixel electrode 190 between a pair of adjacent gate lines 121.

The lower cutting portion 191 is slantingly formed in a left-upward direction from a lower end of the right vertical side of the pixel electrode 190, while the upper cutting portion 193 is slantingly formed in a left-downward direction from an upper end of the right vertical side of the pixel electrode 190. The lower cutting portion 191 and upper cutting portion 193 are placed symmetrically below and above a hypothetical horizontal central line of the pixel electrode 190, respectively, and align with the fourth storage electrode 133d and the third storage electrode 133c. Also, the two cutting portions 191 and 193 are formed at 45° to the adjacent gate lines 121, while being perpendicular to each other.

The central cutting portion 192 is formed along the hypothetical horizontal central line of the pixel electrode 190, and comprises a funnel-shaped opening that is formed inwardly from the right vertical side of the pixel electrode 190 and a horizontal portion extending from a central portion of the opening along the hypothetical horizontal central line. The opening of the central cutting portion 192 has a pair of slanted sides that are substantially parallel to the lower cutting portion 191 and the upper cutting portion 193, respectively.

Accordingly, a lower area of the pixel electrode 190, which is positioned below the hypothetical horizontal central line, is partitioned into two sub-areas by the lower cutting portion 191, while an upper area of the pixel electrode 190, which is positioned above the hypothetical horizontal central line, is partitioned into two sub-areas by the upper cutting portion 193. While a particular embodiment of cutting portions of the pixel electrode 190 has been illustrated and described, the number of sub-areas or the number of cutting portions may be varied depending on some design factors, such as the size of the pixel electrode 190, the length ratio between the vertical side and the horizontal side of the pixel electrode 190, the kind of LC, and the like, and therefore alternate cutting portions and number of sub-areas would be within the scope of these embodiments.

The contact assistants 82 are connected to the end portions 179 of the data lines 171 through the contact holes 182, and supplement adhesion between the exposed end portions 179 and exterior devices, and protect them.

Each overpass 194 spans the gate line 121 of a pixel area and is connected to the exposed portion of the stem line of the storage electrode line 131 and the exposed projection of the free end of the first storage electrode 133a through the contact holes 183 and 184, respectively. Thus, the overpasses 194 span between two adjacent pixel areas, and each pixel area includes a portion of one overpass 194 in a lower section of the pixel area and a portion of a second overpass 194 in an upper section of the pixel area. The overpasses 194 are overlapped with the metal pieces 172 that are disposed on the gate lines 121. The overpasses 194 and the metal pieces 172 may electrically connect to each other. The overpasses 194, the metal pieces 172, and the storage electrode lines 131 having the storage electrodes 133a, 133b, 133c, and 133d may be used for repairing any defect arising from the gate lines 121, the data lines 171, or the TFTs. In this case, when the gate line 121 and the overpass 194 are electrically connected by laser irradiation, the metal piece 172 serves as an auxiliary connector between them.

The common electrode panel 200 of the LCD may be configured as follows.

A light-blocking member 220, also termed “a black matrix”, is provided on an insulating substrate 210 made of transparent glass or the like, in order to prevent light from leaking out through barriers between the pixel electrodes 190. The light-blocking member 220 has as many openings as the number of the pixel electrodes 190. Each opening faces one of the pixel electrodes 190, having substantially the same shape as the pixel electrode 190. Alternately, the light-blocking member 220 may consist of portions corresponding to the gate lines 121, the data lines 171, and the TFTs of the TFT array panel 100.

A plurality of color filters 230 are formed on the substrate 210 having the light-blocking member 220. In exemplary embodiments of the common electrode panel 200, most of the color filters 230 are placed within the openings delimited by the light-blocking member 220. The color filters 230 may extend on the common electrode panel 200 relative to the pixel electrodes 190 in a vertical direction, and are connected to one another as stripes. Each color filter 230 may exhibit one of the red, green, and blue colors, although other colors would be within the scope of these embodiments.

An overcoat layer 250 is formed on the color filters 230.

The common electrode 270, made of a transparent conductor such as ITO or IZO, is formed on the overcoat layer 250. The common electrode 270 may be provided with a plurality of groups of three cutting portions. Each group includes a lower cutting portion 271, a central cutting portion 272, and an upper cutting portion 273, and is placed opposite to one of the pixel electrodes 190.

The three cutting portions 271, 272, and 273 are individually positioned on the common electrode 270 in positions corresponding to positions between the chamfered left-lower corner of the pixel electrode 190 and the lower cutting portion 191, between the central cutting portion 192 and the lower and upper cutting portions 191 and 193, and between the chamfered left-upper corner of the pixel electrode 190 and the upper cutting portion 193. In this structure, each of the cutting portions 271, 272, and 273 has at least one slanted portion that is parallel to the lower cutting portion 191 or the upper cutting portion 193 of the pixel electrode 190. These cutting portions 271, 272, and 273 are inversely symmetrical on the common electrode 270, in positions corresponding to positions centering on the hypothetical horizontal central line bisecting the pixel electrode 190. Because the common electrode 270 may cover an entire surface, or substantially an entire surface, of the common electrode panel 200, the pattern of cutting portions for the common electrode 270 described herein may be repeated on the common electrode 270 for a corresponding number of pixel electrodes 190 provided on the TFT array panel 100.

The lower cutting portion 271 includes a slanted portion extending on the common electrode 270 in a right-downward direction corresponding from the left vertical side of the pixel electrode 190, and a horizontal portion and a vertical portion that extend on the common electrode 270 from both ends of the slanted portion and that form obtuse angles with respect to the slanted portion.

The upper cutting portion 273 includes a slanted portion extending on the common electrode 270 in a right-upward direction corresponding from the left vertical side of the pixel electrode 190, and a horizontal portion and a vertical portion that extend on the common electrode 270 from both ends of the slanted portion of the upper cutting portion 273 and that form obtuse angles with respect to the slanted portion. The horizontal portions and the vertical portions of the lower and upper cutting portions 271 and 273 are formed in positions on the common electrode 270 corresponding to positions along the outline of the pixel electrode 190, partially overlapped with the pixel electrode 190.

The central cutting portion 272 includes a horizontal central portion, a pair of slanted portions, and a pair of vertical portions. The horizontal central portion is formed on the common electrode 270 in a position corresponding to a position along the hypothetical horizontal central line of the pixel electrode 190 from the left side of the pixel electrode 190. The two slanted portions extend toward a position corresponding to the right side of the pixel electrode 190 from an end of the horizontal central portion, and are substantially parallel to the two slanted portions of the lower and upper cutting portions 271 and 273. The two vertical portions of the central cutting portion 272 extend on the common electrode 270 in a position corresponding to a position along the partial right side of the pixel electrode 190, starting from both ends of the relative slanted portions of the central cutting portion 272. In this case, the two vertical portions are correspondingly overlapped with the right side of the pixel electrode 190, and obtuse angles are formed between the two slanted portions and the two vertical portions of the central cutting portion 272.

While a particular embodiment of cutting portions of the common electrode 270 has been illustrated and described, the number of cutting portions in the common electrode 270 may be varied depending on design factors, such as the size of the pixel electrode 190, the length ratio between the vertical side and the horizontal side of the pixel electrode 190, the kind of LC in the LC layer 3, etc. Overlapping of the light-blocking member 220 with the cutting portions 271, 272, and 273 of the common electrode 270 prevents light from leaking out through the cutting portions 271, 272, and 273.

As shown in FIG. 5, a group of the cutting portions 271, 272, 273, 191, 192, and 193 partitions a pixel area into a plurality of sub-areas. Each sub-area has two major sides, forming slanted angles with respect to major sides of the pixel electrode 190. In this structure, the tilt direction of the LC molecules 310 in the LC layer 3 to which an electric field is applied is greatly dependent upon the cutting portions 271, 272, 273, 191, 192, and 193, as will be further described below.

When the common electrode 270 is supplied with a common voltage Vcom and the pixel electrode 190 is supplied with a data voltage, an electric field, which is perpendicular to the surfaces of the two panels 100 and 200, is generated in the LC layer 3. In response to the electric field, the LC molecules 310 in the LC layer 3 begin to change their orientation to be perpendicular to the direction of the electric field.

The cutting portions 191, 192, 193, 271, 272, and 273, and the sides of the pixel electrode 190 create horizontal components in the electric field, which determine tilt directions of the LC molecules 310 in the LC layer 3, by distorting the electric field generated between the two electrodes 190 and 270. The horizontal components are substantially parallel to the sides of the cutting portions 271, 272, 273, 191, 192, and 193 and to the slanted sides of the pixel electrode 190. In this structure, there are about four tilt directions of the molecules 310 because of the horizontal components. In this way, when the LC molecules 310 tilt in various directions, the standard viewing angle of the LCD becomes wider.

Each of the cutting portions 271, 272, 273, 191, 192, and 193 preferably has a width of about 9 μm to about 12 μm, although other dimensions are within the scope of these embodiments.

In other alternative embodiments of an LCD, at least one among the cutting portions 271, 272, 273, 191, 192, and 193 may be replaced with a protrusion (not shown) or a depression (not shown). In this case, the protrusion may be made of an organic material or an inorganic material, and may be placed on or under the pixel electrodes 190 and the common electrode 270. A preferable width of the protrusion is between about 5 μm and about 10 μm, although other dimensions are within the scope of these embodiments.

As previously described, the form and arrangement of the cutting portions 271, 272, 273, 191, 192, and 193 disclosed herein are merely for illustrative purpose, so the cutting portions 271, 272, 273, 191, 192, and 193 may have other forms and arrangements.

The LC layer 3 is interposed between the TFT array panel 100 and the common electrode panel 200, and includes the LC molecules 310 having negative dielectric anisotropy. In the absence of an electric field created by the pixel electrodes 190 on the TFT array panel 100 and the common electrode 270 on the common electrode panel 200, long axes of the LC molecules 310 are aligned substantially perpendicular to the surfaces of the two panels 100 and 200.

Alignment layers 11 and 21 that include, for example, polyamic acid or polyimide are individually coated on the inner surfaces of the panels 100 and 200.

Polarizers 12 and 22 are individually attached to the outer surfaces of the panels 100 and 200. For example, the polarizers 12 and 22 may be attached to outer surfaces of the insulating substrate 110 and the insulating substrate 210, respectively. The transmission axes of the polarizers 12 and 22 are mutually crossed at a right angle. Here, either of the transmission axes is preferably parallel to the gate lines 121. In reflective-type LCDs, either of the two polarizers 12 and 22 may be omitted.

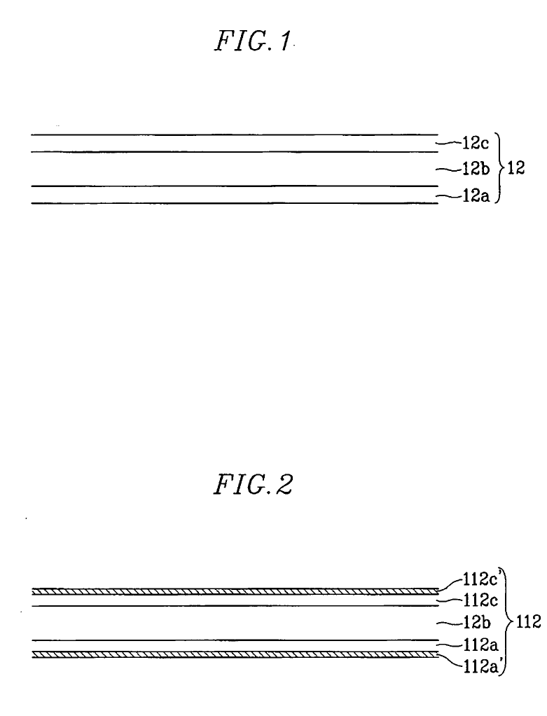

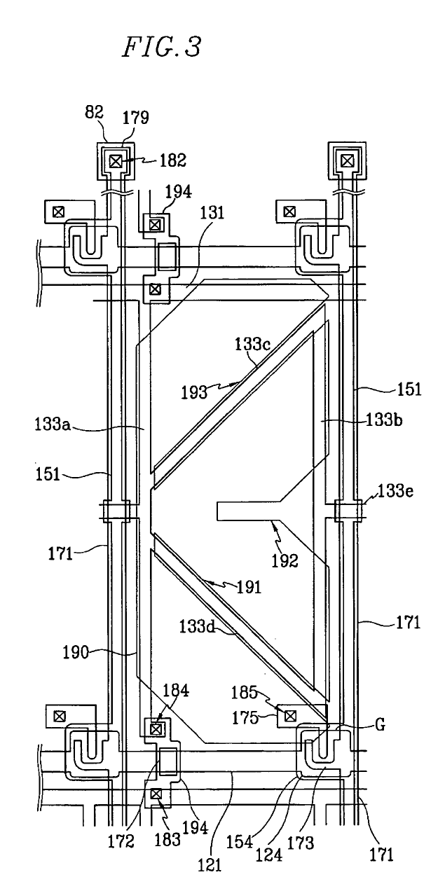

The polarizers 12 and 22 are further described below with reference to FIG. 1 and FIG. 2.

FIG. 1 shows a vertical scheme of an exemplary embodiment of a polarizer 12 according to the present invention.

Referring to FIG. 1, the polarizer 12 includes a lower passivation layer 12a and an upper passivation layer 12c, and a polarizing medium layer 12b interposed between the two passivation layers 12a and 12c. For example, when the polarizer 12 is attached to the TFT array panel 100, the upper passivation layer 12c may be disposed on the insulating substrate 110. Alternatively, the lower passivation layer 12a may be disposed on the insulating substrate 110.

The polarizing medium layer 12b is a polyvinyl-alcohol-based (“PVA”) film. The polarizing medium layer 12b may be obtained by dyeing a PVA film with iodine molecules or bichromatic dyes and stretching the film in a desired direction such that the iodine molecules or the bichromatic dyes are aligned in the stretched direction.

The lower and upper passivation layers 12a and 12c, which are individually provided under and over the polarizing medium layer 12b, are mainly made of triacetate cellulose (“TAC”), and serve as protection films for the polarizing medium layer 12b .

In addition to serving as protection films for the polarizing medium layer 12b, the passivation layers 12a and/or 12c include conductive polymers therein, for efficient removal of an electric charge incoming from the outside, such as from an exterior of the LCD to an interior of the LCD. The conductive polymers can rapidly discharge such a charge from the outside back to the outside, thus preventing the charge from entering an interior of the LCD.

In the present invention, polyaniline or polythiophene is used as the conductive polymer included within either or both of the passivation layers 12a and 12c.

Polyanline, which is a compound having aromatic rings with amino groups, accelerates the transfer speed of a charge that enters the polarizer 12 from an exterior of the polarizer 12, such as an exterior of the LCD to which the polarizer 12 is attached, since it has a conjugated system of benzene rings. Accordingly, the static charge in the polarizer 12 can be discharged to the outside in a short time. Also, because of nitrogen (N) atoms in the amino groups that are regularly aligned between the benzene rings, polyaniline exhibits good compatibility with TAC which is the main constituent of the passivation layers 12a and 12c.

Similar to polyaniline, polythiophene, which is a compound having hetero rings with sulfonic groups, can discharge a static charge to the outside in a short time by accelerating the transfer speed of a charge incoming from the outside. This is possible because polythiophene has a conjugated system of hetero rings. In polythiophene, sulfur (S) atoms in the sulfonic groups are regularly aligned between the hetero rings, instead of N atoms as in polyaniline. Accordingly, similarly to polyaniline, polythiophene also exhibits good compatibility with TAC.

As described above, when each of the passivation layers 12a and 12c includes TAC and the conductive polymer with a good static dissipative property, such as polyaniline or polythiophene, the charge entering the polarizer 12 (and similarly polarizer 22) from the outside of the panels 100 and 200 is rapidly discharged to the outside again due to the conductive polymer within one or both of the passivation layers 12a and 12c, so that defects and a lowering of voltage characteristics that are caused by such a static charge during sequential processes are remarkably reduced and a lowering voltage characteristic caused by the static charge is prevented.

Since both polyaniline and polythiophene exhibit excellent compatibility with TAC, a mixture of TAC and either one of polyaniline or polythiophene can be used to form the passivation layers 12a and 12c. Also, TAC and polyaniline or polythiophene that are mixed in water or alcohol can be used. The content of polyaniline or polythiophene in the mixture is preferably determined within a range where the static charge can be efficiently eliminated.

For example, for efficient removal of the static charge, each of the passivation layers 12a and 12c preferably has a conductivity of 10⁸ Ω/cm² to 10¹² Ω/cm². In order for each of the passivation layers 12a and 12c to have conductivity within such a range, the content of polyaniline or polythiophene in each of the passivation layers 12a and 12c is preferably between about 0.1% and about 10% by weight based on the total solid weight of each passivation layer 12a and 12c. If the content of polyaniline or polythiophene is below 0.1% by weight, then the conductivity of each of the passivation layers 12a and 12c would be too feeble to discharge the static charge to the outside. Whereas, if the content of polyaniline or polythiophene is above 10% by weight, then the conductivity of each of the passivation layers 12a and 12c would become too high, thus affecting the two panels 100 and 200.

Most preferably, each of the passivation layers 12a and 12c includes polyaniline or polythiophene ranging from 3% to 5% by weight based on the total solid weight of each passivation layer 12a and 12c.

FIG. 2 shows a polarizer 112 having a different structure than the polarizer 12 of FIG. 1. The polarizer 112 is obtained by a different method from the method of forming the polarizer 12 of FIG. 1. That is, TAC layers 112a and 112c are first laminated on a polarizing medium layer 12b, and then conductive polymer layers 112a′ and 112c′, both including polyaniline or polythiophene, are laminated on the TAC layers 112a and 112c, respectively, thereby completing the polarizer 112.

This method has an advantage that other conductive polymers exhibiting a relatively low compatibility with TAC can also be used, in addition to polyaniline and polythiophene which exhibit good compatibility with TAC, together with a problem that the passivation layers are produced through more complex steps. In this case, examples of the available conductive polymers for the conductive polymer layers 112a′ and 112c′ may be included polyaniline, polythiophene, and polypyrrole.

Such a conductive polymer may be included on at least one of the TAC layers 112a and 112c.

In each of the above-described embodiments, the lower polarizer 12 attached to the TFT array panel 100 and the upper polarizer 22 attached to the common electrode panel 200 may be configured in the same manner. In an alternative embodiment, only one of the two polarizers 12 and 22 may utilize the conductive polymers to form the passivation layers.

As described above, the polyaniline-based or polythiophene-based conductive polymers existing in the passivation layers of the polarizers discharge the static charge incoming from an outside of the panels back to the outside in a short time.

While the above-mentioned embodiments were only discussed with VA mode LCDs, the present invention may also be applicable to TN mode LCDs or IPS mode LCDs.

Thus, the present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A polarizer comprising:
a polarizing medium layer; and
a passivation layer that is formed on or under the polarizing medium layer, wherein the passivation layer includes a conductive polymer.

2. The polarizer of claim 1, wherein the passivation layer is a first passivation layer formed on the polarizing medium layer, the polarizer further comprising a second passivation layer formed under the polarizing medium layer, the polarizing medium layer disposed between the first passivation layer and the second passivation layer.

3. The polarizer of claim 2, wherein the second passivation layer includes a conductive polymer.

4. The polarizer of claim 2, wherein at least one of the first passivation layer and the second passivation layer includes a first protective layer adjacent the polarizing medium layer and an outer conductive layer.

5. The polarizer of claim 1, wherein the conductive polymer includes at least one conductive polymer selected from a group consisting of polyaniline, polythiophene, and polypyrrole.

6. The polarizer of claim 5, wherein the passivation layer includes triacetate cellulose.

7. The polarizer of claim 1, wherein the passivation layer includes triacetate cellulose.

8. The polarizing plate of claim 1, wherein the passivation layer is made of a mixture of triacetate cellulose and at least one of polyaniline and polythiophene.

9. The polarizer of claim 8, wherein the passivation layer includes polyaniline or polythiophene ranging from 0.1% to 10% by weight based on a total solid weight of the passivation layer.

10. The polarizer of claim 8, wherein the passivation layer includes polyaniline or polythiophene ranging from 3% to 5% by weight based on a total solid weight of the passivation layer.

11. The polarizer of claim 1, wherein the passivation layer includes a double-layered structure including a first layer containing triacetate cellulose and a second layer containing at least one conductive polymer selected from the group consisting of polyaniline, polythiophene, and polypyrrole.

12. The polarizer of claim 1, wherein the polarizing medium layer includes polyvinyl alcohol.

13. The polarizer of claim 12, wherein the polyvinyl alcohol is dyed with iodine molecules or bichromatic dyes.

14. The polarizing plate of claim 1, wherein the passivation layer has a conductivity of 10⁸ Ω/cm² to 10¹² Ω/cm^{2.}

15. A liquid crystal display comprising:
a first insulating substrate;
a gate line formed on the first insulating substrate;
a data line formed on the first insulating substrate and crossed with the gate line at a right angle;
a thin film transistor connected to the gate line and the date line;
a pixel electrode connected to the thin film transistor;
a second insulating substrate placed opposite to the first insulating substrate;
a common electrode formed on the second insulating substrate;
a liquid crystal layer interposed between the first insulating substrate and the second insulating substrate; and
a polarizer attached to either of outer surfaces of the first and second insulating substrates,
wherein the polarizer includes a polarizing medium layer and a passivation layer, the passivation layer formed on or under the polarizing medium layer and containing a conductive polymer.

16. The liquid crystal display of claim 15, wherein the passivation layer is a first passivation layer formed on the polarizing medium layer, the polarizer further comprising a second passivation layer formed under the polarizing medium layer, the polarizing medium layer disposed between the first passivation layer and the second passivation layer.

17. The liquid crystal display of claim 16, wherein the second passivation layer includes a conductive polymer.

18. The liquid crystal display of claim 15, wherein the polarizer is a first polarizer attached to the first insulating substrate, the liquid crystal display further comprising a second polarizer attached to the second insulating substrate.

19. The liquid crystal display of claim 18, wherein the second polarizer includes a passivation layer containing a conductive polymer.

20. The liquid crystal display of claim 15, wherein the conductive polymer includes at least one conductive polymer selected from the group consisting of polyaniline, polythiophene, and polypyrrole.

21. The liquid crystal display of claim 20, wherein the passivation layer includes triacetate cellulose.

22. The liquid crystal display of claim 15, wherein the passivation layer includes triacetate cellulose.

23. The liquid crystal display of claim 15, wherein the passivation layer is made of a mixture of triacetate cellulose and at least one of polyaniline and polythiophene.

24. The liquid crystal display of claim 23, wherein the passivation layer includes polyaniline or polythiophene ranging from 0.1% to 10% by weight based on a total solid weight of the passivation layer.

25. The liquid crystal display of claim 15, wherein the passivation layer includes a double-layered structure including a first layer containing triacetate cellulose and a second layer containing at least one of polyaniline and polythiophene.

26. The liquid crystal display of claim 15, wherein the pixel electrode has a cutting portion.

27. The liquid crystal display of claim 15, wherein the liquid crystal layer has negative dielectric anisotropy with liquid crystal molecules that are aligned perpendicular to surfaces of the first and second insulating substrates.

28. The liquid crystal display of claim 15, further comprising a member for determining tilt directions of the liquid crystal molecules.

29. The liquid crystal display of claim 28, wherein the member for determining tilt directions includes a cutting portion formed in at least one of the pixel electrode and the common electrode, or a protrusion formed on at least one of the pixel electrode and the common electrode.

30. The liquid crystal display of claim 15, wherein the polarizer discharges static charges entering the polarizer from an exterior of the liquid crystal display back to the exterior of the liquid crystal display.

31. The liquid crystal display of claim 15, wherein the polarizer prevents static charges from an exterior of the liquid crystal display from lowering voltage characteristics of the liquid crystal display.
